(19) United States
(12) Patent Application Publication
(10) Pub. No.: US 2003/0049859 A1
(43) Pub. Date: Mar. 13, 2003

(54) Method of analysis using x-ray fluorescence

(76) Inventors: Alexander Henrich, Hoganas (SE); Konrad Beckenkamp, Seeheim (DE); Oliver Mandal, Wesel (DE); Matthias Ohm, Rossdorf (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/220,857

(22) PCT Filed: Feb. 13, 2001
(86) PCT No.: PCT/EP01/01580

(30) Foreign Application Priority Data
Mar. 9, 2000 (DE) 100 11 115.7

(51) Int. Cl. G01N 21/76

(52) U.S. Cl. 436/172; 436/164; 422/82.05; 422/82.08; 422/82.09

(57) ABSTRACT

The invention relates to an improved method of analysis using X-ray fluorescence, whereby the X-ray fluorescence is excited by X-radiation. Said X-radiation is generated with an acceleration tension of between 5 and 60 kV and is radiated in an unfiltered form, i.e. without a primary ray filter being positioned in the ray path. The measured data is evaluated according to methods which are known in principle, whereby the area of the deceleration continuum is taken into account in the evaluation. The invention also relates to the application of the improved method for energy dispersive X-ray fluorescence analysis for analyzing chemical substances and to a device for carrying out said method.

The present invention relates to novel X-ray fluorescence analysis (XFA) methods, in particular novel measurement and evaluation methods, and to the use of these methods in analytical methods for the differentiation and classification of chemical substances.

The quality management of process chains in the chemical industry requires confirmation of the identity of the chemical substances in the process chain. This applies, for example, during packing of small packages, where the risk of misclassification and the proportion of unambiguously identified samples must offer the requisite statistical certainty without the time needed for measurement methods and evaluation being in impracticable orders of magnitude.

Thus, for example, it is possible to check the identity of the substances using combined FT-NIR-Raman spectrometers; suitable instruments are commercially available. However, some substances (substances of the NaCl, metal and metal oxide crystal type) can only be analysed with considerable uncertainty using this combined analytical method, or not at all. These substances can be identified, for example, using X-ray fluorescence analysis (XFA); this is carried out, for example, using energy-dispersive X-ray fluorescence spectrometers (EDXFS), which are also commercially available.

The substance identification method using an EDXFS is based on calculation of the EDXFA spectra using multivariate methods [1]. This identification method allows rapid substance identification by comparison of a recorded spectrum with a spectrum filed in the library (classification) with the aid of regularised discriminant analysis (RDA, method: determination of the discrimination minimum by calculation of the Mahalanobis distance and the variance-covariance matrix) [2], [3], [4], [5], [6], [7], [8] and prior principal component analysis (PCA, method: NIPALS algorithm, prior centering) [9],[10],[11] or the BRUKER identification programme (OPUS®; method: distance determination from the euclidian distance) [12].

To date, an excitation voltage of 35 kV has been employed for the substance identification (see Table 1; excitation in accordance with the prior art, [1]). The energy range from 5 to 18 keV is excited very well in this case. In addition, the elastic and inelastic scattering ranges and the fluorescence lines up to 32 keV can be detected very well using this excitation condition. In these measurement and evaluation methods, the narrow-band fluorescence lines, in particular, are evaluated. In order to reduce background signals, in particular those of the Brems continuum, and to improve the signal/noise ratio, primary ray filters are employed. The papers on optimisation of the EDXFS for automatic identification of chemicals in a packing plant show that it is not possible to identify all substances with adequate reliability using a single excitation condition. Some substances are wrongly identified using this excitation condition (increased risk of misclassification). A new excitation condition is now intended to provide optimum excitation of the spectral information from 2-5 keV in order to utilise this information for chemometric identification of substances. The excitation conditions proposed in accordance with the invention are compared with those used to date in Table 1.

Objective

The aim is to reduce the risk of misclassification for substance identification using EDXFA with little adverse effect on the measurement time and measurement process.

Achievement of the Object

The problem has been solved by the use of a further excitation condition. This new excitation condition excites the spectral range 2-5 keV in an optimum manner (characteristic K and L X-rays, L lines of Ag X-ray tubes); this information is thus utilised in an optimum manner for multivariate statistical identification of substances. The two excitation conditions are compared in standardised form in Table 1. Spectra recorded using the excitation condition according to the invention exhibit the form shown in FIG. 2. Besides the L lines of the Ag X-ray tube, diffraction maxima caused by diffraction of the white, uncollimated X-rays at the lattice planes of the crystal are evident [13], [14]. These effects are undesired in quantitative EDXFA and have hitherto usually been suppressed by the use of filters [15].

TABLE 1
Comparison between the conventional and new excitation
conditions in the EDXFS

| | Excitation | Excitation |
|---|---|---|
| Parameter | (prior art) | (new) |
| Anticathode material | Ag | Ag |
| Acceleration voltage/kV | 35 | 12 |
| Current strength/μA | 30 | 30 |
| Primary ray filter | thin Ag | none |
| Number of channels | 4096 | 1024 |
| Measurement time/s | 100 | 100 |
| Detectable element range | CI to I (K lines), | Si to Zn (K lines), |
| | I to U (L lines) | Y to W (L lines) |
| Atmosphere | air | air |

The invention relates to improved X-ray fluorescence analysis methods in which the X-ray fluorescence is excited by X-rays generated with an acceleration voltage of from 5 to 60 kV without filtration, i.e. without a primary ray filter in the ray path. The angle between the primary and secondary rays (characteristic and scattered radiation) in X-ray fluorescence analysis is usually between 60 and 1200. The measurement data are evaluated by methods known in principle, with the range of the Brems continuum and the X-ray diffraction maxima being included in the evaluation. The invention furthermore relates to the use of the improved X-ray fluorescence analysis method for the qualitative and quantitative analysis of chemical substances. The invention furthermore relates to an apparatus for the measurement of X-ray fluorescence which comprises a primary ray source having an X-ray tube and associated voltage supply, where the primary ray source emits an unfiltered primary radiation, furthermore comprising a sample holder and a detection device for characteristic and scattered radiation (secondary radiation), with the angle between the primary and secondary rays typically being between 60 and 120°. In preferred embodiments, the said apparatus additionally comprises a evaluation device, preferably programme-controlled, which enables the identity of the sample to be determined from the characteristic and scattered radiation measured at the sample by comparison with data sets for characteristic and scattered radiation measured on standard substances.

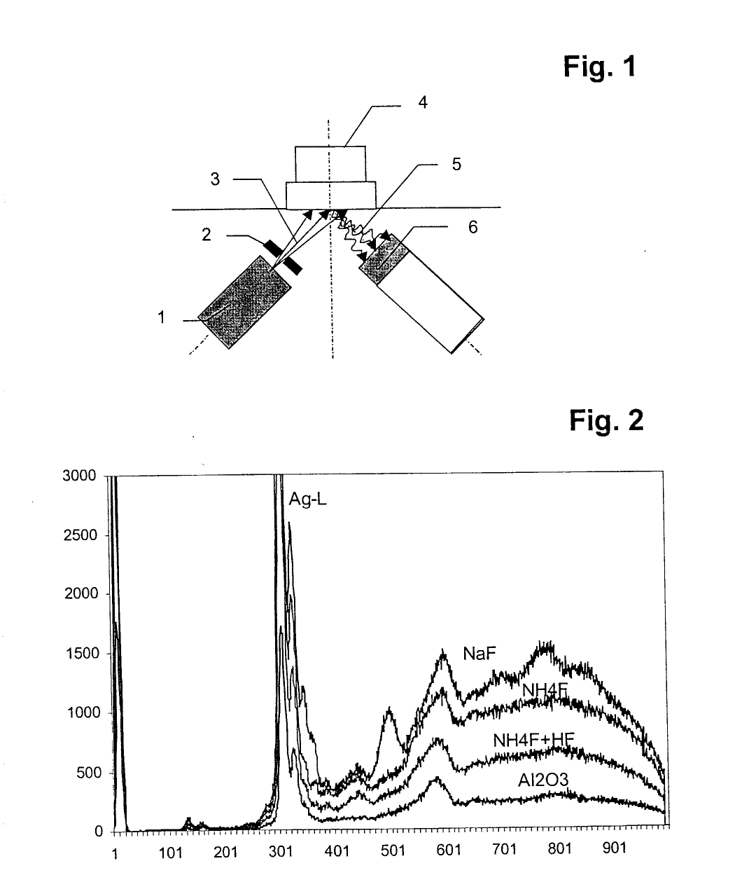

FIG. 1 shows a diagrammatic view of the structure of a typical measurement arrangement comprising an X-ray tube, where the primary ray filter device does not contain a filter, the sample holder and the Si(Li) semiconductor detector. Also indicated is the ray path with primary radiation and the characteristic and scattered radiation (secondary radiation).

FIG. 2 shows the comparison of the various diffraction patterns in the EDXFA spectrum of the substances Al₂O₃, NaF, NH₄F and NH₄F+HF, excitation voltage: 12 kV, no primary ray filter, detector current strength: 30 μA, measurement time: 100 s.

The various diffraction patterns, excited in accordance with the invention with 12 kV and without primary ray filter, are shown in FIG. 2 using the example of the substances Al₂O₃, NaF, NH₄F and NH₄F+HF. The spectra of the four substances differ in their diffraction patterns. Use of the excitation condition according to the invention thus enables reliable identification of the chemicals, which either exhibit no characteristic lines and diffraction patterns or very intense fluorescence lines owing to the collimated primary ray at an excitation voltage of 35 kV.

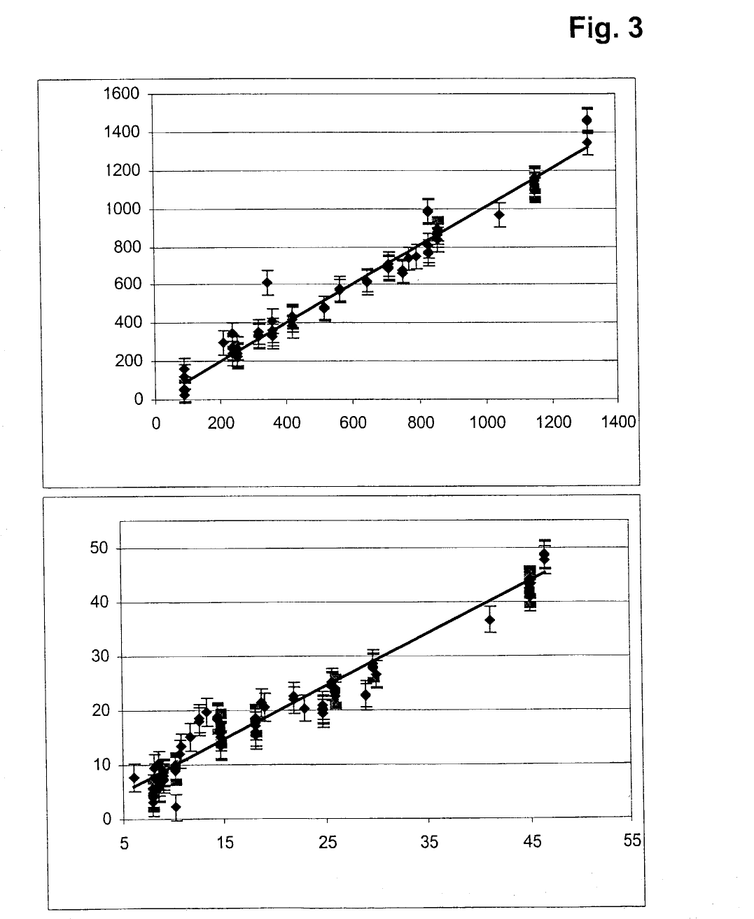

FIG. 3 shows the plot of “pre-specified/predicted value from the PLS prediction for μ_{average} from excitation condition 12 kV (top) and for OZ_{average} from excitation condition 35 kV (bottom) as well as R² and RMSEP as Y errors.

The design of the X-ray tubes which are suitable for generation of the excitation radiation is known to the person skilled in the art; suitable X-ray tubes and measurement devices are also commercially available. In X-ray tubes of this type, metals known to the person skilled in the art, such as, for example, Ag, Co, Cu, Mo, Pd, Rh or W, serve as anticathode material. In accordance with the invention, a conventional acceleration voltage for X-ray fluorescence analysis, typically from 5 to 60 kV, more preferably from 8 to 15 kV, is used. In accordance with the invention, no primary ray filter is provided in the ray path.

The method according to the invention is equally suitable for use on the basis of energy-dispersive and wavelength-dispersive X-ray fluorescence analysis. Correspondingly, the comments in the description which relate to energy-dispersive X-ray fluorescence analysis (EDXFA) should merely be understood as being illustrative.

For substance identification with the aid of multivariate, statistical classification methods, the entire spectral region, i.e. scattering region and Brems continuum, is used in accordance with the invention since the various diffraction patterns for the substances are also characteristic in an EDXFA spectrum. Overall, the method according to the invention also enables quantitative analyses in addition to substance identification.

A library data set consisting of 19 substances (see Example 1) and a sample data set consisting of 27 samples has been analysed using commercial identification programmes (OPUS IDENT® from BRUKER; euclidian distance, and SCAN for Windows®, Minitab; combined PCA-RDA). The results for identification of the sample data set are shown in Table 2 as misclassification risk (in %) for the original spectra (I spectra) and the smoothed spectra (A spectra) of the two excitation conditions (12 kV and 35 kV).

TABLE 2
Results for the identification of the sample data set as mis-
classification risk (in %) from the different methods

| | | Euclidian | |
|---|---|---|---|
| Excitation | Conversion | distance | PCA-RDA |
| voltage | type | (OPUS ®) | (SCAN f.W) |
| 12 kV | I spectrum | 18.5 | 18.5 |
| 12 kV | A spectrum | 18.5 | 18.5 |
| 35 kV | I spectrum | 44.4 | 22.2 |
| 35 kV | A spectrum | 44.4 | 18.5 |

The following results can be derived from these results of chemical identification by classification:

For the data set (library and sample), the misclassification risk is reduced by half through the use of excitation condition “12 kV” in identification using OPUS in comparison with excitation condition “35 kV”.

Smoothing of the spectra does not bring about a significant reduction in the misclassification risk with an excitation voltage of 12 kV.

Through the use of the second excitation condition (12 kV), chemical identification using OPUS is at least equal to identification with PCA-RDA for this data set.

The data set used for the classification was also used for the prediction with “partial least square regression” (PLS) [9], [10], [11]. A PLS prediction enables the model created and used in the classification to be interpreted as in mathematics as a function with which a Y value (for example physical parameter) is calculated or predicted from a given X value (for example spectrum). Besides the two physical parameters of average atomic number (AN_{average}) [16] and average mass attenuation coefficient (μ_{average}(Ag-Lα)) [17], crystallographic parameters (edge lengths a, b and c of the elemental cell, elemental-cell volume and the theoretical substance density [18]) were additionally inserted as prediction parameters into the PLS as Y values for the 2nd excitation condition (12 kV).

The results from the PLS predictions for the second excitation condition (12 kV) are shown in Table 3 in the form of the determination coefficient (R²) and the error of prediction of the model (RMSEP) from the “specified/-predicted parameter” plot (see FIG. 2). At the same time, the determination coefficient from the calculations for the first excitation condition (35 kV, primary filter) are shown for comparison for some selected parameters.

TABLE 3
R² and RMSEP from the regression calculations “pre-specified/
predicted parameter” for the PLS predictions for the two
excitation conditions 12 kV and 35 kV (entire spectral region)

| Predicted | R² | RMSEP/ | R² | RMSEP/ |
|---|---|---|---|---|
| parameter | (12 kV) | % | (35 kV) | % |
| AN_{average} | 0.9364 | 12.16 | 0.9557 | 12.19 |
| μ_{average}(energy)/ | 0.9712 | 9.42 | 0.8579 | 35.74 |
| cm²*g⁻¹ | | | | |
| Volume of | 0.3823 | — | −2.9334 | — |
| elemental cell/Å³ | | | | |
| Density/g*cm⁻¹ | 0.8566 | — | 0.8041 | — |
| Edge length a/Å | 0.3279 | — | — | — |
| Edge length b/Å | 0.7551 | — | — | — |
| Edge length c/Å | 0.6725 | — | — | — |
| a/b | −2.7624 | — | — | — |
| c/b | 0.7128 | — | — | — |

Greater prediction accuracy (based on the available PLS model) can be achieved from the results of chemical identification by a PLS prediction of physical parameters using μ_{average}(Ag-Lα) for the excitation voltage 12 kV compared with AN_{average} for the excitation voltage 35 kV.

Due to the excitation condition according to the invention (12 kV), the reliability of unambiguous identification of chemicals with chemometric classification increases. A prediction of physical parameters and thus conclusions regarding pure substances is thus likewise possible with the PLS model.

This model is further improved by further measures which are known in principle; these measures include, in particular, wavelet pretreatment, smoothing, derivation and standardisation of the spectra.

Even without further comments, it is assumed that a person skilled in the art will be able to utilise the above description in its broadest scope. The preferred embodiments and examples should therefore merely be regarded as descriptive disclosure which is absolutely not limiting in any way.

The complete disclosure content of all applications, patents and publications mentioned above and below and of the corresponding application DE 100 11 115.7, filed on Sep. 3, 2000, are incorporated into this application by way of reference.

### EXAMPLES

### Example 1

### Comparison of the Two Excitation Conditions with an Identical Data Set (Library and Samples) with Respect to Substance Identification Using OPUS IDENT® and RDA (Classification)

A library data set consisting of 37 reference spectra of 19 different substances (see Table 4), and a sample data set consisting of 27 sample spectra was measured using the two excitation conditions described above. The spectra, in binary format, were converted firstly into the original spectra (I spectra) and secondly into the smoothed average spectra (A spectra), in the form of ASCII files. Table 5 shows the channel ranges for the respective conversion type for the classification and later prediction.

TABLE 4
Substances and their two physical parameters “average atomic
number (AN_{average}) and average mass attenuation coefficient for
the Ag-Lα line (μ_{average}(Ag-Lα) present in different specifications
in the library.

| Empirical | | μ_{average} |
|---|---|---|
| formula | AN_{average} | (Ag-Lα)/cm²/g |
| Al₂O₃ | 10.6 | 514.0 |
| NH₄F + HF | 7.8 | 236.0 |
| NH₄F | 7.4 | 208.4 |
| Cd | 48.0 | 535.7 |
| C | 6.0 | 88.2 |
| Cu | 29.0 | 753.0 |
| CuCl | 24.7 | 1043.9 |
| Cu(NO₃)₂ + 3H₂O | 13.2 | 340.8 |
| CuO | 24.8 | 644.2 |
| KBr | 29.7 | 955.8 |
| KCl | 18.0 | 856.4 |
| Kl | 45.0 | 641.6 |
| KlO₃ | 36.7 | 545.2 |
| Al/Cu/Zn | 21.9 | 770.3 |
| PbO | 76.7 | 1430.3 |
| LiCl | 14.7 | 1310.2 |
| NaCH₃COO | 8.0 | 250.9 |
| NaBr | 29.6 | 1137.7 |
| NaCl | 14.6 | 1149.3 |
| NaF | 10.1 | 415.4 |
| Nal | 46.6 | 732.7 |
| Na₂HPO₄ + 12H₂O | 8.5 | 314.7 |
| Na₂HPO₄ + 7H₂O | 8.9 | 357.2 |
| Na₂SO₄ | 10.8 | 562.0 |
| Pb(NO₃)₂ | 54.2 | 1027.0 |
| Sn | 50.0 | 624.1 |
| SnO₂ | 41.1 | 536.6 |
| Zn | 30.0 | 831.3 |
| ZnO | 25.7 | 709.5 |
| ZrO₂ | 31.7 | 1515.5 |

TABLE 5
Channel ranges employed for the calculation for the
respective conversion type

| Excitation | | Lower | Upper |
|---|---|---|---|
| voltage | Conversion type | channel | channel |
| 12 kV | I spectrum | 120 | 900 |
| 12 kV | A spectrum | 24 | 200 |
| 35 kV | I spectrum | 65 | 3420 |
| 35 kV | A spectrum | 15 | 685 |

In the OPUS Ident programme, the library was first constructed using the average spectra from the 37 reference spectra of different substances, internal validation was then carried out, and finally the 27 samples were identified using the method created. The method created and used was the standard method (euclidian distance) without vector standardisation for all four data sets (12 kV, I spectra; 12 kV, A spectra; 35 kV, I spectra; 35 kV, A spectra).

In identification using RDA, firstly the significant principal components (PC) were determined with the aid of PCA. The library and sample data set was then prepared from the significant PC for the RDA classification. In addition, an RDA classification based on the A spectra for the excitation condition “12 kV” was calculated.

The results from the internal validation as unambiguously identified substances (in %) for the individual methods are shown in Table 6, and the results for identification of the sample data set as misclassification risk (in %) are shown in Table 2 (see above).

TABLE 6
Results for internal validation as unambiguously identified
articles (in %) from the various methods

| Excitation | | Euclidian distance | PCA-RDA |
|---|---|---|---|
| voltage | Conversion type | (OPUS ®) | (SCAN f.W) |
| 12 kV | I spectrum | 79.5 | 98.8 |
| 12 kV | A spectrum | 82.6 | 99.4 |
| 35 kV | I spectrum | 30.6 | 82.3 |
| 35 kV | A spectrum | 31.8 | 79.4 |

### Example 2

### Comparison of the Two Excitation Conditions with an Identical Data Set (Library and Samples) with Respect to Correlation of Substance-Specific Physical Parameters with PLS (Prediction)

The data set used for the classification was likewise used for the prediction with PLS. Besides the two physical parameters AN_{average} and μ_{average}(Ag-Lα), crystallographic parameters (edge lengths a, b and c of the elemental cell, volume of the elemental cell and the theoretical density of the substance were additionally employed as prediction parameters in the PLS for the 2nd excitation condition (12 kV).

The results from the PLS predictions for the second excitation condition (12 kV) are shown in Table 7 in the form of the determination coefficient from the “specified/predicted parameter” plot. At the same time, the determination coefficient from the calculations for the first excitation condition (35 kV) is shown for comparison for some selected parameters.

TABLE 7
Determination coefficient from the regression calculations “pre-
specified/predicted parameter” for the PLS predictions of the
two excitation conditions 12 kV and 35 kV (entire spectral region)

| Predicted parameter | R² (12 kV) | R² (35 kV) |
|---|---|---|
| AN_{average} | 0.9329 | 0.9494 |
| μ_{average} | 0.9877 | 0.9409 |
| (12 kV: Ag-Lα, 35 kV: Ag-Compton-Kα)/ | | |
| cm²*g⁻¹ | | |
| Volume of elemental cell/Å³ | 0.3823 | −2.9334 |
| Density/g*cm⁻¹ | 0.8566 | 0.8041 |
| Edge length a/Å | 0.3279 | — |
| Edge length b/Å | 0.7551 | — |
| Edge length c/Å | 0.6725 | — |
| a/b | −2.7624 | — |
| c/b | 0.7128 | — |
| μ*density/cm⁻¹ | 0.8839 | 0.8814 |
| AN/density/cm²*g⁻¹ | 0.8274 | 0.7801 |

The following results can be derived from these results of chemical identification by prediction of physical parameters using PLS:

In spite of diffraction phenomena in the lower energy range (2-10 keV), crystallographic parameters are not suitable for a prediction.

The two physical parameters AN_{average} and μ_{average} are the most suitable for chemical identification by prediction of physical parameters from the EDXFA spectra.

μ_{average}(Ag-Lα) for the excitation voltage 12 kV exhibits greater prediction accuracy (based on the available PLS model) compared with AN_{average} for the excitation voltage 35 kV.

### LITERATURE

[1] Henrich, A., Dissertation 1999 Technical University of Darmstadt

[2] Baldovin, A.; Wen, W.; Massart, D. L.; Turello, A., “Regularised discriminant analysis RDA—Modeling for the binary discrimination between pollution types” Chemom. Intell. Lab. Syst. 1997 381, 25-37

[3] Mallet, Y.; Coomans, D.; de Vel, O., “Recent developments in discriminant analysis on high dimensional spectral data” Chemom. Intell. Lab. Syst. 1996 352,157-173

[4] Wu, W.; Mallet, Y.; Walczak, B.; Penninckx, W.; Massart, D. L.; Heuerding, S.; Erni, F., “Comparison of regularised discriminant analysis, linear discriminant analysis and quadratic discriminant analysis, applied to NIR data” Anal. Chim. Acta 1996 3293, 257-265

[5] Wu, W.; Massart, D. L. “Regularised nearest neighbor classification method for pattern recognition of near infrared spectra” Anal. Chim. Acta 1997 3491-3, 253-261

[6] Frank, I. E.; Friedman, J. H., “Classification: oldtimers and newcomers” J. Chemom. 1989 33,463-75

[7] Friedman, J. H., “Regularised Disciminant Analysis” J. Am. Stat. Assoc. 1989 84,165-175

[8] Johnson, R. A.; Wichern, D. W., Applied Multivariate Statistical Analysis 1982 Prentice Hall, New Jersey

[9] Esbensen, K.; Schönkopf, S.; Midtgaard, T., Multivariate Analysis in Practice 1994 Wennbergs Trykkeri AS, Trondheim

[10] Einax, J., Chemometrics in enviromental analysis 1997 VCH Verlagsgesellschaft, Weinheim

[11] Henrion, R.; Henrion, G., Multivariate Datenanalyse [Multivariate data analysis] 1994 Springer-Verlag Berlin, Heidelberg, N.Y.

[12] Mandal, O., Dissertation 1999 University of Duisburg

[13] Bish, D. L.; Post, J. E. (editors) Modern Powder Diffraction 1989 The Mineralogical Society of America

[14] Zevin, L. S.; Kimmel, G. Quantitative X-Ray Diffractometry 1995 Springer Verlag

[15] Vane, R. A.; Stewart, W. D., “The effective use of filters with direct excitation of EDXRF” Adv. X-Ray Anal. 1980 23, 231-239

[16] Kunzendorf, H., “Quick Determination of the avarage atomic number Z by X-ray scattering” Nuclear Instruments and methods 1972 99, 611-612

[17] Zschornak, G., Atomdaten für die Röntgenspektralanalyse 1989 432-465, Springer-Verlag, Berlin

[18] Jenkins, R.; Andreson, R.; McCarthy, G. J., Powder Diffraction File 1992 International Centre for Diffraction Data, Pennsylvania, USA

Reference Symbols

FIG. 1:

1 X-ray tube

2 Primary ray filter device (without primary ray filter)

3 Primary radiation

4 Sample in spectrocup

5 Characteristic and scattered radiation

6 Si(Li) semiconductor detector

FIG. 2:

x-axis: channel; y-axis: count rate/pulses

The Ag-L lines are indicated with Ag-L.

FIG. 3:

Top plot:

x-axis: μ_{average}(Ag-La)/cm²/g (predicted);

y-axis: μ_{average}(Ag-La)/cm²/g (pre-specified)

The values indicated by squares standing on a corner show μAgLa(pred), the straight line shows the linear regression Linear(μAgLa(pred)). The linear regression gave the equation y=1.0087x. The correlation coefficient R² was found to be R²=0.9715.

Bottom plot:

x-axis: AN_{average} (predicted)

y-axis: AN_{average} (pre-specified)

The values indicated by squares standing on a corner show AN(average)(pred), the straight line shows the linear regression Linear(AN(average)(pred). The linear regression gave the equation y=0.9751 x. The correlation coefficient R² was found to be R²=0.9464.

1. Improved X-ray fluorescence analysis method, in which the X-ray fluorescence is excited by X-rays, characterised in that the said X-rays are generated with an acceleration voltage of from 5 to 60 kV and are incident without filtration.

2. Use of the method according to claim 1 for the analysis of chemical substances.

3. Apparatus for the measurement of X-ray fluorescence, which comprises a primary ray source having an X-ray tube and associated voltage supply, where the primary ray source emits unfiltered primary radiation, furthermore comprising a sample holder and a detection device for characteristic and scattered radiation.

4. Apparatus according to claim 3, additionally comprising an evaluation device which enables the identity of the sample to be determined from the characteristic and scattered radiation measured on the sample by comparison with data sets for characteristic and scattered radiation measured on standard substances.
